(19) United States
(12) Patent Application Publication
(10) Pub. No.: US 2008/0036188 A1
(43) Pub. Date: Feb. 14, 2008

(54) Apparatus for controlling flow of inflation fluid through a vent opening of an air bag module

(75) Inventors: Douglas M. Gould, Lake Orion, MI (US); Kurt F. Fischer, Leonard, MI (US); William P. Braun, Romeo, MI (US); Michael J. Loyd, Rochester Hills, MI (US); Colleen Kalczynski, Shelby Township, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/502,786

(22) Filed: Aug. 11, 2006

(51) Int. Cl. B60R 21/26; B60R 21/239

(52) U.S. Cl. 280/739; 280/743.2; 280/740

(57) ABSTRACT

An apparatus for controlling flow of inflation fluid through a vent opening (50) in an air bag module (10) includes a vent member (14) movable to control flow of the inflation fluid through the vent opening. The vent member (14) includes a vent member opening (84) extending through the vent member. A tether (12) for controlling movement of the vent member (14) includes a first portion (90) and second portion (92). The second portion (92) is folded to form multiple layers (112, 114). The tether (12) is positioned relative to the vent member (14) so that the multiple layers (112, 114) of the second portion (92) engage a first side (62) of the vent member. The first portion (90) of the tether (12) extends through the vent member opening (50) and away from an opposite second side (60) of the vent member (14). The engagement of the second portion (92) with the vent member (14) causes the vent member (14) to move in response to movement of the tether (12).

### TECHNICAL FIELD

The present invention relates to an apparatus for controlling flow of inflation fluid through a vent opening of an air bag module, and more specifically, to an apparatus including a tether attached to a vent member that controls a flow of inflation fluid through a vent opening in an air bag module.

### BACKGROUND OF THE INVENTION

It is known to provide a vent opening in a housing of an air bag module for venting inflation fluid away from an air bag. A vent member is associated with the vent opening and is movable relative to the housing for controlling the flow of inflation fluid through the vent opening. Commonly, the position of the vent member is dependent upon a position of an occupant of a seat associated with the air bag module. For example, in some air bag modules, an actuator that moves the vent member is controlled in response to signals from an occupant position sensor.

In other air bag modules, a tether extends between a panel of the air bag and the vent member. When the panel of the air bag moves relative to the air bag module housing by a distance that is greater than a predetermined amount, the tether pulls the vent member to move the vent member relative to the housing. Such an air bag module is disclosed in United States Published Patent Application No. 2004/0051285A1, which is assigned to the assignee of the present invention.

In air bag modules that use a tether to adjust the position of the vent member, the tether must be attached to the vent member. One method of attaching the tether to the vent member is to extend the tether through a slot in the vent member and then form a knot in the tether. When the tether is pulled taut, the knot abuts the outside surface of the vent member to transfer a force from the tether to the vent member. Another method of attaching the tether to the vent member is to extend the tether through a slot in the vent member and then attach a clip to the tether. When the tether is pulled taut, the clip abuts the outside surface of the vent member to transfer a force from the tether to the vent member.

### SUMMARY OF THE INVENTION

The present invention relates to an apparatus for controlling flow of inflation fluid through a vent opening in an air bag module. The apparatus includes a vent member movable to control flow of the inflation fluid through the vent opening. The vent member includes a vent member opening that extends through the vent member. A tether for controlling movement of the vent member includes a first portion and second portion. The second portion is folded to form multiple layers. The tether is positioned relative to the vent member so that the multiple layers of the second portion engage a first side of the vent member. The first portion of the tether extends through the vent member opening and away from an opposite second side of the vent member. The engagement of the second portion with the vent member causes the vent member to move in response to movement of the tether.

The present invention also relates to an apparatus for controlling flow of inflation fluid through a vent opening in an air bag module. The apparatus includes a vent member movable to control flow of the inflation fluid through the vent opening and a tether for controlling movement of the vent member. The tether includes first and second portions. The second portion of the tether is folded to form multiple layers. The first portion of the tether extends from the multiple layers. The tether is positioned relative to the vent member so that the multiple layers of the second portion are maintained in engagement with a surface of the vent member. The engagement of the folded second portion with the surface of the vent member causes the vent member to move in response to tension on the first portion of the tether.

The present invention also relates to an apparatus for controlling flow of inflation fluid through a vent opening in an air bag module. The apparatus includes a vent member movable to control flow of the inflation fluid through the vent opening. A tether controls movement of the vent member. The tether includes first and second portions. The second portion includes portions of the tether folded into multiple layers and secured to help maintain the folded multiple layer configuration of the second portion. The first portion extends through an opening in the vent member. The second portion is sized to form an interference with the vent member so that movement of the tether effects movement of the vent member.

The present invention further relates to an apparatus for helping to protect an occupant of a vehicle. The apparatus includes an inflatable vehicle occupant protection device inflatable between structure of the vehicle and a vehicle occupant. An inflation fluid source provides inflation fluid for inflating the protection device. Structure defines a housing for supporting the protection device and the inflation fluid source. The housing includes a vent opening. A vent member is movable to control inflation fluid flow through the vent opening. The vent member includes a vent member opening extending through the vent member. A tether controls movement of the vent member. The tether includes first and second portions. The second portion is folded to form multiple layers that engage a first side of the vent member. The first portion of the tether extending through the vent member opening and away from an opposite second side of the vent member. The first portion of the tether is configured for movement in response to deployment of the protection device. The engagement of the second portion with the vent member causes the vent member to move in response to movement of the first portion of the tether.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a sectional view of a portion of a vehicle occupant protection apparatus having a tether attached to a vent member in accordance with the present invention showing the vent members in a first condition;

FIG. 2 is a view similar to FIG. 1 showing the vent members in a second condition;

FIG. 3 is a plan view of a vent member of the vehicle occupant protection apparatus of FIG. 1;

FIG. 4 is an elevation view of a portion of a tether in accordance with a first embodiment of the present invention;

FIG. 5 is an elevation view illustrating the portion of the tether in a first folded condition;

FIG. 6 is a view taken along line 6-6 in FIG. 5;

FIG. 7 is an elevation view illustrating the portion of the tether in a second folded condition;

FIG. 8 is a view taken along line 8-8 in FIG. 7;

FIG. 9 illustrates the tether being inserted into a slot of the vent member;

FIG. 10 illustrates the tether extending through the slot of the vent member;

FIG. 11 illustrates the tether attached to the vent member;

FIGS. 12-15 are perspective views illustrating the construction of a tether for a vent member of a vehicle occupant protection apparatus in accordance with a second embodiment of the present invention;

FIGS. 16-18 are perspective views illustrating the assembly of the tether of FIGS. 12-15 and a vent member of a vehicle occupant protection apparatus;

FIGS. 19 and 20 are perspective views illustrating a tether for a vent member of a vehicle occupant protection apparatus in accordance with a third embodiment of the present invention; and

FIGS. 20 and 21 are perspective views illustrating a tether for a vent member of a vehicle occupant protection apparatus in accordance with a fourth embodiment of the present invention.

### DETAILED DESCRIPTION OF THE INVENTION

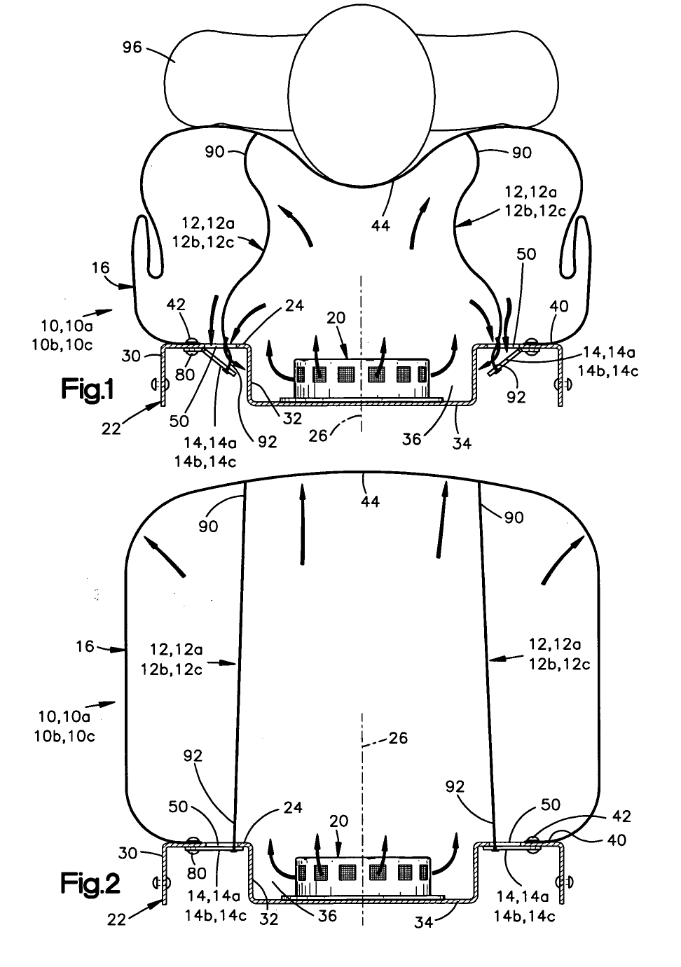

FIG. 1 is a sectional view of a portion of a vehicle occupant protection apparatus 10 having tethers 12 attached to associated vent members 14 in accordance with the present invention. The vehicle occupant protection apparatus 10 of FIG. 1 is an air bag module having an inflatable occupant protection device 16 in the form of an air bag. As an alternative to an air bag 16, the inflatable occupant protection device may be an inflatable seat belt, an inflatable knee bolster, an inflatable head liner, an inflatable side curtain, or a knee bolster operated by an inflatable air bag.

The air bag module 10 also includes an inflator 20 for providing inflation fluid for inflating the air bag 16. The inflator 20 may be any type of inflator that is actuatable for providing inflation fluid. FIGS. 1 and 2 illustrate an inflator 20 for use in a driver-side frontal air bag module.

The inflator 20 and the air bag 16 are supported on a support member 22 of the air bag module 10. The support member 22 is attachable to the vehicle and receives reaction forces from the inflator 20 and the air bag 16 when the inflator is actuated. The support member 22 illustrated in FIGS. 1 and 2 is a reaction plate.

The reaction plate 22 has an annular main body portion 24 that is centered on an axis 26. A cylindrical outer wall 30 of the reaction plate 22 extends downward, as viewed in FIG. 1, from the main body portion 24. A cylindrical inner wall 32 extends downward from the main body portion 24 and parallel to the outer wall 30, at a location spaced radially inward, relative to axis 26, of the outer wall. A circular center wall 34 caps the inner wall 32 of the reaction plate 22. The inner wall 32 and the center wall 34 of the reaction plate 22 define a cylindrical inflator mounting chamber 36. The inflator 20 is located in the chamber 36 and is secured to the reaction plate 22.

A mouth portion 40 of the air bag 16 is secured to the main body portion 24 of the reaction plate 22 by an annular retainer 42. The mouth portion 40 defines an inflation fluid opening in the air bag 16 for receiving inflation fluid from the inflator 20. Opposite the mouth portion 40, the air bag 16 has an outer panel 44 that is presented toward a vehicle occupant 96 when the air bag is inflated. Prior to inflation of the air bag 16, the air bag 16 is folded so that the outer panel 44 is located proximate the reaction plate 22. During inflation of the air bag 16, the outer panel 44 moves away from the reaction plate 22. FIG. 1 illustrates the air bag 16 in a partially inflated condition. FIG. 2 illustrates the air bag 16 in a fully inflated condition.

The reaction plate 22 includes two vent openings 50. The two vent openings 50 are located on diametrically opposite sides of the axis 26 and are formed in the main body portion 24 of the reaction plate 22 at a location radially inward of the mouth portion 40 of the air bag 16. The vent openings 50 may be formed in other portions of the reaction plate, such as in the inner wall 32 or the center wall 34 at locations spaced radially outward, relative to axis 26, of the inflator 20. The vent openings 50 are identical to each other, and each vent opening has a generally rectangular configuration. During inflation of the air bag 16, inflation fluid may flow through the vent openings 50 and away from the air bag 16.

The air bag module 10 of FIGS. 1 and 2 also includes two vent members 14 for selectively closing the vent openings 50. Each vent member 14 is associated with a different vent opening 50. In FIGS. 1 and 2, the two vent members 14 are identical to one another.

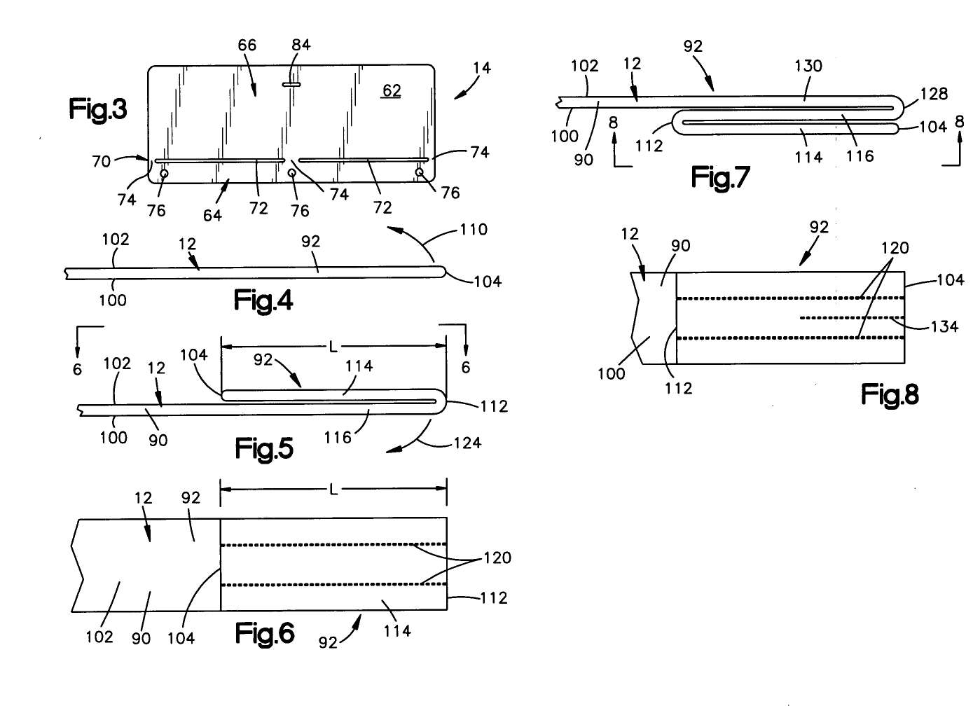

FIG. 3 is a plan view of one of the vent members 14 of the air bag module 10 of FIGS. 1 and 2. The vent member 14 shown in FIG. 3 is planar and has a generally rectangular configuration. The vent member 14 includes opposite inner and outer surfaces 60 and 62 (FIGS. 10-12), respectively. As shown in FIG. 3, the vent member 14 includes an attaching portion 64 and a closing portion 66. A living hinge 70 separates the attaching portion 64 and the closing portion 66. The living hinge 70 is formed by two collinear, elongated slots 72 that extend through the vent member 14 and define three hinge portions 74. The living hinge 70 enables bending of the closing portion 66 of the vent member 14 relative to the attaching portion 64.

The attaching portion 64 of the vent member 14 includes three apertures 76. Each aperture 76 is adapted for receiving an associated fastener 80 for fixing the attaching portion 64 of the vent member 14 to the main body portion 24 of the reaction plate 22. FIGS. 1 and 2 illustrate a portion of one of the fasteners 80 that secure the attaching portion 64 of each vent member 14 to the main body portion 24 of the reaction plate 22. The fasteners 80 illustrated in FIGS. 1 and 2 also secure the retainer 42 relative to the main body portion 24 of the reaction plate 22.

The closing portion 66 of each vent member 14 has dimensions that are greater than the dimensions of its associated vent opening 50. An opening 84 extends through the closing portion 66 of the vent member 14 in a location spaced apart from the living hinge 70. As illustrated, the opening 84 is a slot, but other configurations of the opening may be used in the present invention.

The vent members 14 have first and second conditions. FIG. 1 illustrates the vent members 14 in the first condition. FIG. 2 illustrates the vent members 14 in the second condition. When in the first condition, the closing portion 66 of each vent member 14 is spaced apart from its associated vent opening 50 in the reaction plate 22 so that inflation fluid may pass through the vent opening. When in the second condition, the closing portion 66 of the vent member 14 abuts the reaction plate 22 to cover its associated vent opening 50 so as to block inflation fluid from passing through the vent opening. The vent member 14 bends at the living hinge 70 when moving between the first and second conditions.

The air bag module 10 of FIGS. 1 and 2 includes two tethers 12 for controlling the condition of the vent members 14. Each tether 12 is associated with a different vent member 14. For example, the tethers 12 may be narrow, elongated strips of fabric material (e.g., braided nylon or polyester) having widths of approximately three-eights of an inch.

As shown in FIGS. 1 and 2, each tether 12 has a first portion 90 and a second portion 92. The first portion 90 of each tether 12 is attached to its associated vent member 14 in accordance with the present invention. The second portion 92 of each tether 12 extends from the first portion 90 and has a terminal end fixed to the outer panel 44 of the air bag 16. Preferably, the second portion 92 of each tether 12 is sewn to the outer panel 44 of the air bag 16. The second portion 92 of each tether 12 is thus connected for movement with the outer panel 44 of the air bag.

When the air bag 16 is in the deflated condition (not shown) and the outer panel 44 of the air bag is proximate the reaction plate 22, a significant amount of slack is present in each of the tethers 12. The slack is present because the length of the tethers 12 is greater than the distance between the outer panel 44 of the air bag 16 and the vent members 14.

When actuated, the inflator 20 emits a large volume of inflation fluid. The inflation fluid flows into the air bag 16 through the mouth portion 40. When the vent members 14 are in the first condition, some of the inflation flows out of the vent openings 50 and is diverted away from the air bag 16. The vent members 14 may be located in the first condition prior to actuation of the inflator 20. Alternatively, the vent members 14 may be moved to the first condition upon actuation of the inflator 20. For example, inflation fluid pressure may move the vent members 14 from the second condition to the first condition prior to rupturing of a cover (not shown) of the air bag module 10.

As the air bag 16 inflates, the outer panel 44 of the air bag 16 moves away from the reaction plate 22 and away from the vent members 14. When the outer panel 44 of the air bag 16 moves away from the reaction plate 22 by a distance that is less than a predetermined amount, slack remains in the tethers 12. This might happen, for example, if the inflating air bag 16 contacts an object, such as an occupant 96, positioned relatively close to the reaction plate 22, as shown schematically in FIG. 1. When slack remains in the tethers 12, the vent members 14 remain in the first condition, spaced apart from the vent openings 50 and enable the flow of inflation fluid away from the air bag 16 through the vent openings. This venting reduces the force and pressure with which the air bag 16 inflates.

When the outer panel 44 of the air bag 16 moves away from the reaction plate 22 by a distance that is equal to or greater than the predetermined amount, the tethers 12 are pulled taut. Movement of the outer panel 44 away from the reaction plate 22 by a distance greater than the predetermined amount transfers a force from the outer panel, through the tethers 12, to the vent members 14. The outer panel 44 of the air bag 16 may move by a distance greater than the predetermined amount, for example, when the air bag 16 inflates fully to help protect a vehicle occupant seated against a backrest portion (not shown) of a vehicle seat (not shown).

The force transferred to the vent members 14 through the tethers 12 acts to move the vent members from the first condition toward the second condition. When the vent members 14 are in the second condition, the vent members 14 close the vent openings 50 and block the flow of inflation fluid through the vent openings and away from the air bag 16. As a result, the air bag 16 inflates with full force and pressure.

When the air bag module 10 of FIGS. 1 and 2 is assembled, the tethers are secured to the outer panel 44 of the air bag 16 prior to being secured to the vent members 14. When the air bag 16 is packed in its deflated condition relative to the reaction plate 22, the first portion 90 of each tether 12 is pulled through an associated vent opening 50. The first portion 90 of each tether 12 is then secured to its associated vent member 14. The vent members 14 are then attached to the reaction plate 22 using the fasteners 80.

FIGS. 4-11 illustrate the method by which the first portion 90 of each tether 12 is attached to its associated vent member 14 in accordance with a first embodiment of the present invention. FIG. 4 illustrates a plan view of the first portion 90 of one of the tethers 12. As illustrated in FIG. 4, the tether 12 includes lower and upper surfaces 100 and 102, respectively, and a terminal end 104. In accordance with the method of the present invention, the first portion 90 of the tether 12 is laid flat and is folded into the configuration illustrated in FIG. 5 by moving the terminal end 104 in the direction indicated by arrow 110 in FIG. 4. When folded into the configuration of FIG. 5, the first portion 90 of the tether 12 includes a first fold line 112 that separates an upper, first layer 114 and a lower, second layer 116, respectively. The first layer 114 has a predetermined length that is indicated by L in FIG. 5.

After folding the tether 12 into the configuration of FIG. 5, the first and second layers 114 and 116 are secured together. In the embodiment of FIGS. 4-11, the first and second layers 114 and 116 are sewn together. The layers 114 and 116 could, however, be secured together by alternative means, such as ultrasonic welding, heat bonding, adhesives, or mechanical fasteners. FIG. 6 schematically illustrates two longitudinally extending stitch lines 120 that extend from the first fold line 112 to the terminal end 104. A double needle lock stitch is used for added strength.

After the first and second layers 114 and 116 are secured together, the first portion 90 of tether 12 is folded into the configuration illustrated in FIG. 7 by moving the secured first and second layers 114 and 116 in the direction indicated by arrow 124 in FIG. 5. When folded into the configuration of FIG. 7, the first portion 90 of the tether 12 also includes a second fold line 128 that separates the second layer 116 from a third layer 130. As a result, the second layer 116 is interposed between the first and third layers 114 and 130, respectively, and between the first and second fold lines 112 and 128, respectively, and has a length equal to the length L of the first layer 114. In the configuration of FIG. 7, the second fold line 128 is located adjacent to the terminal end 104.

Next, the first, second, and third layers 114, 116, and 130 are secured together. As shown in FIG. 8, the layers 114, 116, and 130 are sewn together by a longitudinally extending stitch line 134 that extends parallel to and between stitch lines 120. The stitch line 134 extends through and helps secure the first, second, and third layers 114, 116, and 130 of the tether 12 to each other. A double needle lock stitch is used for added strength.

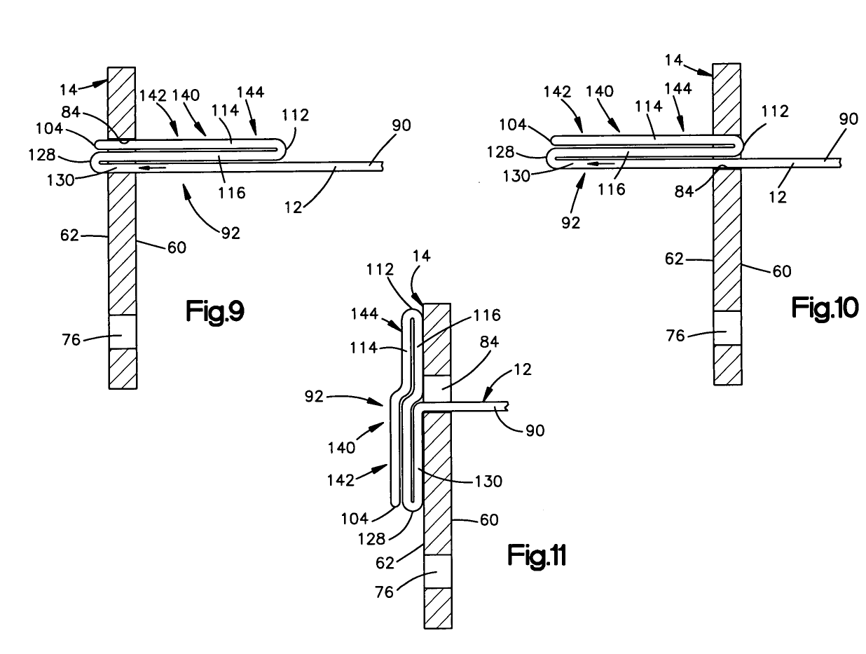

Referring to FIG. 9, when the first, second, and third layers 114, 116, and 130 are secured together, an attachment member 140 is formed at the first portion 90 of the tether 12. The attachment member 140 illustrated in FIG. 9 includes a first portion 142 that is formed from the first, second, and third layers 114, 116, and 130 and a second portion 144 that is formed from the first and second layers. Thus, the second portion 144 of the attachment member 140 includes one layer less than the first portion 142 of the attachment member 140. Although FIG. 9 illustrates the first portion 142 of the attachment member 140 having three layers and the second portion 144 having two layers, the first portion 142 may have any number of layers greater than one with the second portion 144 having at least one layer less than the first portion.

To attach the first portion 90 of the tether 12 to the vent member 14, the attachment member 140 is inserted into the slot 84 of the vent member 14, as indicated generally by the arrow in FIG. 9. The entire attachment member 140 is passed through the slot, as shown in FIG. 10. This may be done by pulling on the first portion 142 once it passes through the slot 84 until the first and second portions 142 and 144 of the attachment member abut the inner surface 60 of the vent member, as shown in FIG. 10.

After the attachment member 140 has been pulled through the slot 84, the second portion 92 of the tether 12 is pulled to place both the first portion 142 and the second portion 144 of the attachment member 140 in abutting engagement with the outer surface 62 of the vent member 14, as shown in FIG. 11.

When both the first and second portions 142 and 144 of the attachment member 140 are in abutting engagement with the outer surface 62 of the vent member 14, as shown in FIG. 11, the attachment member 140 resists being pulled through the slot 84 in response to tension in the tether 12. Specifically, as illustrated in FIG. 11, tension in the tether 12 tends to pull the center of the attachment member 140, adjacent the stitch line 134, into the slot 84. As a result, five layers of the tether 12 (i.e., three layers of the first portion 142 of the attachment member 140 and two layers of the second portion 144) are pulled toward the slot 84. The five layers of the tether 12 together are too thick to pass through the slot 84 and, thus, pull through of the attachment member 140 is resisted. Instead of being pulled through the slot 84, as the tether 12 is tensioned, the attachment member 140 presses against the outer surface 62 of the vent member 14 and transfers a force from the tether 12 to the vent member for moving the vent member to the second condition.

The present invention enables an accurate positioning of the attachment member 140 along the length of the tether 12. As a result, the tethers 12 of the air bag module 10 may have a uniform length so that the vent members 14 are all moved to the second condition at the same position of the outer panel 44 as it moves during inflation of the air bag 16. Additionally, uniformity of the tether lengths is maintained in the manufacture of multiple air bag modules so that all of the air bag modules will have similar performances.

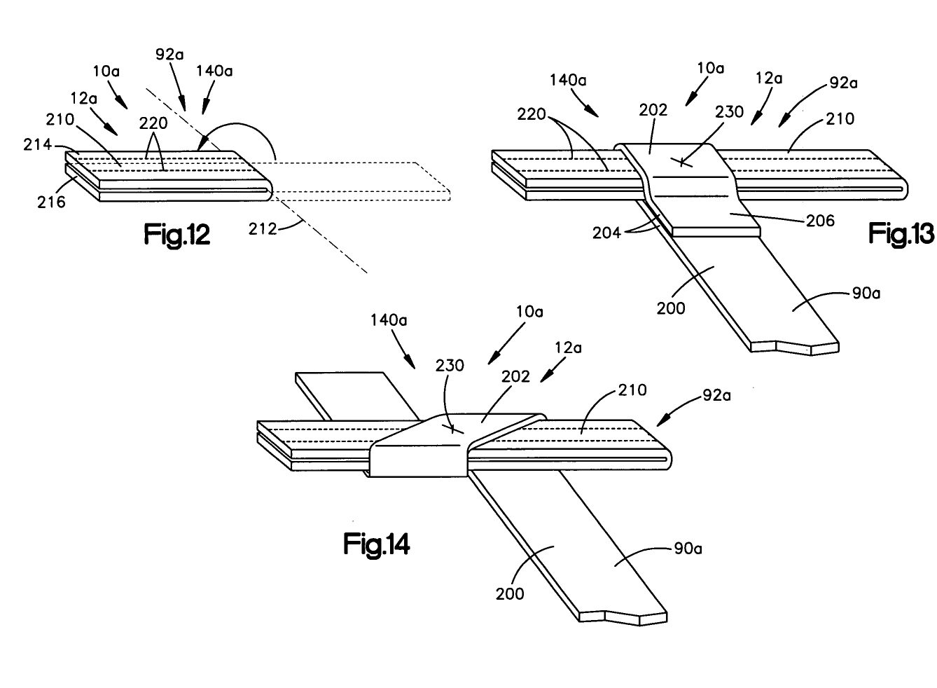

A second embodiment of the present invention is illustrated in FIGS. 12-18. The second embodiment of the present invention is similar to the first embodiment of the invention illustrated in FIGS. 1-11. Accordingly, reference numbers similar to those of FIGS. 1-11 will be utilized in FIGS. 12-18, the suffix letter “a” being associated with the reference numbers of FIGS. 12-18 to avoid confusion.

FIGS. 12-15 illustrate a perspective view of one of the tethers 12a of the vehicle occupant protection apparatus 10a. The tethers 12a include a first portion 90a and a second portion 92a. According to the second embodiment, the tether 12a comprises an attachment member 140a that includes a main portion 200, cross piece 210, and a shield piece 250 that are secured together as described below. The cross piece 210 helps define the first portion 90a of the tether 12a. The main portion 200 helps define the second portion 92a of the tether 12a.

The main portion 200, cross piece 210, and shield portion 250 may have a material construction similar or identical to that of the first embodiment. For example, the main portion 200 and cross piece 210 may be narrow, elongated strips of fabric material (e.g., braided nylon or polyester) having widths of approximately three-eights of an inch. The shield portion 250 may comprise a widened strip constructed of a material that is the same as or different from that used to construct the main portion 200 and cross piece 210.

Referring to FIG. 12, the first portion 90a of the tether 12a, i.e., the cross piece 210, comprises a piece of material having a predetermined length (e.g., about six inches) that is folded, as indicated by the arrow, about a fold line 212 to form overlying first and second portions 214 and 216, respectively. The first and second portions 214 and 216 are secured to each other by known means, such as stitching. For example, as shown in FIG. 12, the first and second portions 214 and 216 may be secured to each other by stitch lines 220. The portions 214 and 216 could, however, be secured to each other by alternative means, such as ultrasonic welding, heat bonding, adhesives, or mechanical fasteners. In FIG. 12, the stitch lines 220 comprise two parallel stitch lines that extend the length of the cross piece 210 from the fold line 212 to an opposite end 222 of the cross piece. For added strength, a double needle lock stitch may be used to form the stitch lines 220.

After the first and second portions 214 and 216 are secured together, the second portion 92a of the tether 12a, i.e., the main portion 200, of the tether 12a is arranged perpendicular to the cross piece 210. This is shown in FIG. 13. A terminal end portion 202 of the main portion 200 of the tether 12a is then folded or wrapped around a central portion of the cross piece 210. The position of the main portion 200 relative to the cross piece 210 may be maintained by securing the main portion to the cross piece via means 2320, such as a tack stitch.

As shown in FIG. 13, the terminal end portion 202 may be folded to form overlying portions 204. In this instance, the terminal end portion 202 may extend around the entire width of the cross piece 210, leaving an overhang portion 206 that extends beyond the cross piece. The overhang portion 206 may, for example, have a length of one-half inch or less. Alternatively, as shown in FIG. 14, the terminal end portion 202 may extend around the cross piece 210 in a spiral fashion and may be connected via the tack stitch 230. In this instance, an overhang portion may be avoided.

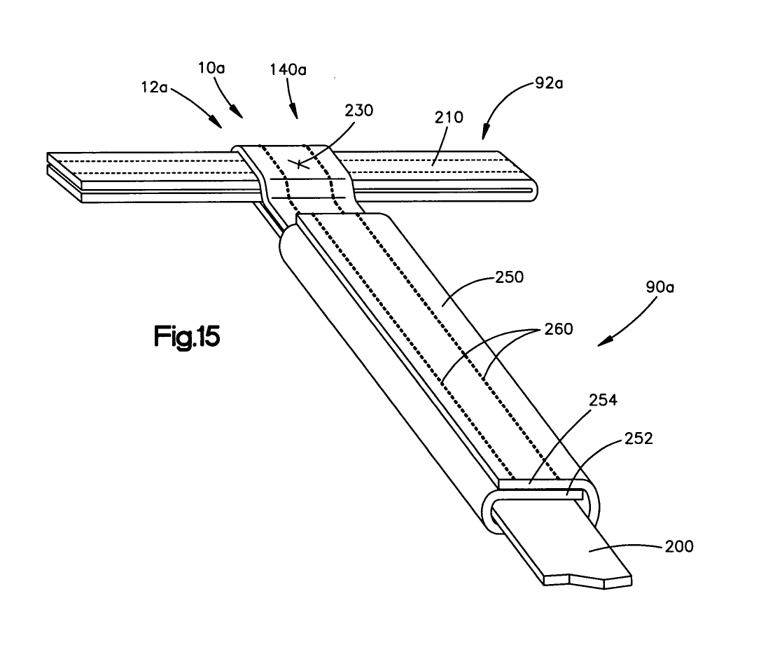

Referring to FIG. 15, the shield piece 250 is arranged with its length oriented parallel to the main portion 200. The shield piece 250 is wrapped around the main portion 200 such that first and second longitudinal end portions 252 and 254, respectively, of the shield piece overlie each other and extend across the width of the main portion. The main portion 200 is secured to the cross piece 210, and the shield portion 250 is secured to the main portion via means 260, such as stitch lines (e.g., double needle lock stitching). As shown in FIG. 15, there are two stitch lines 260 that extend parallel to each other and parallel to the length of the main portion 200. The stitch lines 260 extend through the end portions 252 and 254, through the main portion 200, and through the portion of the shield portion 250 that underlies the main portion. The shield piece 250 may extend from the cross piece 210 along any desired portion of the main portion 200.

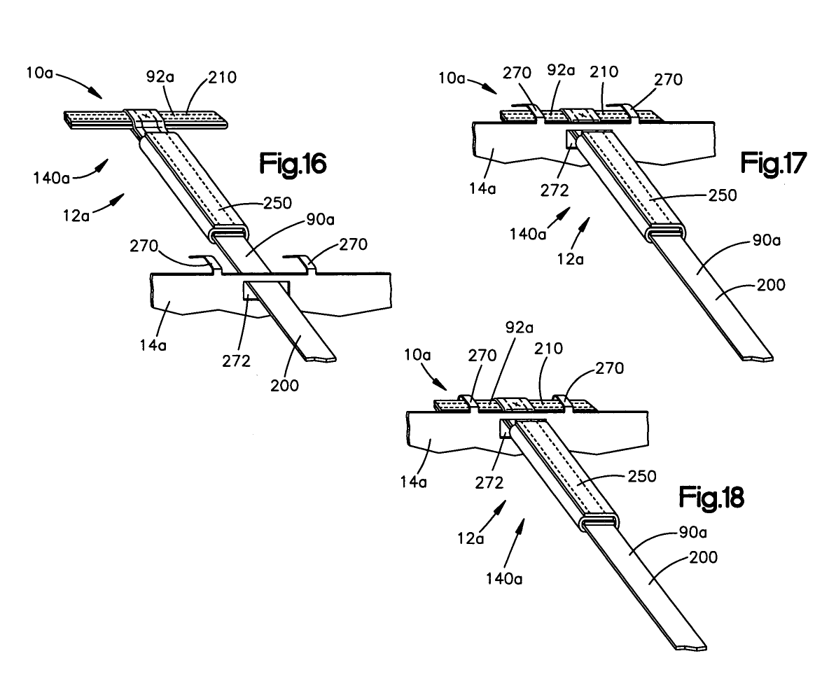

The vent member 14a may have a configuration that is similar or identical to that illustrated in the first embodiment. In the second embodiment, the vent member 14a includes bend tabs 270 for helping to secure the attachment member 140a to the vent member. As shown in FIGS. 16 and 17, the main portion 200 and shield portion 250 are positioned extending through an opening 272 of the vent member 14a. This may be done in a variety of manners.

For example, the main portion 200 and shield portion 250 may be positioned extending through the opening 272 by first inserting the main portion 200 and shield portion through the opening and backing the attachment member 140a into engagement with the vent member 14a. Alternatively, the cross member 210 may be folded or otherwise placed extending parallel to the main portion 200 and the attachment member 140a may be inserted first through the opening 272 in a manner similar to that described above in regard to the first embodiment.

Once the main portion 200 and shield portion 250 are positioned extending through the opening 272, the cross member 210 is pulled tight against the vent member 14a. This is shown in FIG. 17. With the tether 12a in the position shown in FIG. 17, the bend tabs 270 are bent around the cross piece 210 to help further secure the cross piece, and thus the first portion 90a of the tether 12a, to the vent member 14a. The bend tabs 270 may exert a clamping force that helps secure the tether 12a to the vent member 14a.

When the tether 12a is tensioned, the crosspiece 210 is urged against the vent member 14a and transfers a force from the tether to the vent member for moving the vent member to the second condition. The present invention enables an accurate positioning of the attachment member 140a along the length of the tether 12a. As a result, the tethers 12a of the air bag module 10a may have a uniform length so that the vent members 14a are all moved to the second condition at the same position of the outer panel as it moves during inflation of the air bag (see FIGS. 1 and 2). Additionally, uniformity of the tether lengths is maintained in the manufacture of multiple air bag modules so that all of the air bag modules will have similar performances.

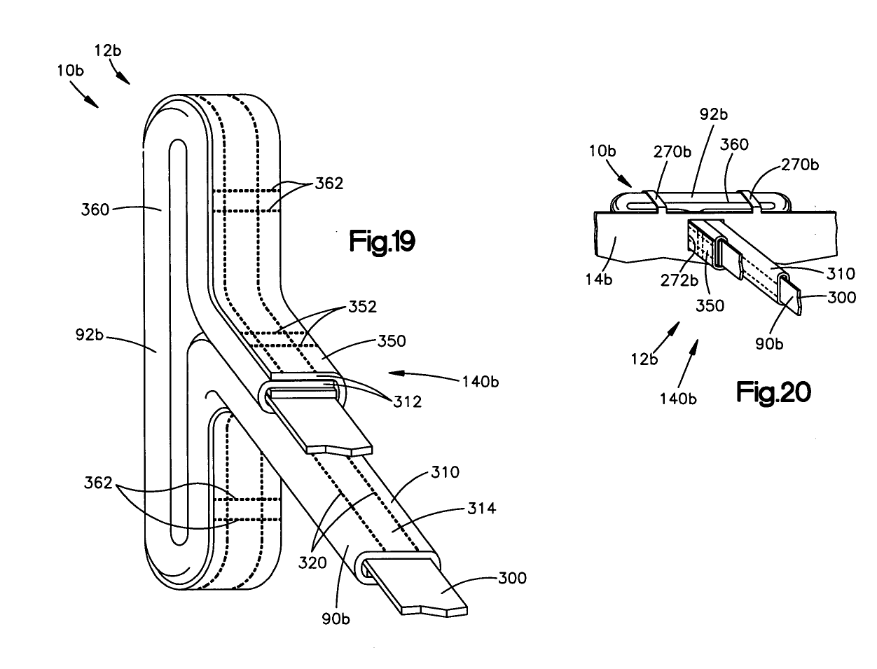

A third embodiment of the present invention is illustrated in FIGS. 19 and 20. The third embodiment of the present invention is similar to the second embodiment of the invention illustrated in FIGS. 12-18. Accordingly, reference numbers similar to those of FIGS. 12-18 will be utilized in FIGS. 19 and 20, the suffix letter “b” being associated with the reference numbers of FIGS. 19 and 20 to avoid confusion.

FIG. 19 illustrates a perspective view of one of the tethers 12b of the vehicle occupant protection apparatus 10b. The tether 12b includes a first portion 90b and a second portion 92b. According to the third embodiment, the tether 12b comprises a length of tether material that defines a tether piece 300 and a shield piece 310 that are secured to each other and folded to form an attachment member 140b as described below.

The tether piece 300 and shield piece 310 may have a material construction similar or identical to those described above in regard to the tether of the first embodiment. For example, the tether piece 300 may be a narrow elongated strip of fabric material (e.g., braided nylon or polyester) having widths of approximately three-eights of an inch. The shield piece 310 may comprise a widened strip constructed of a material that is the same as or different from that used to construct the tether piece 300.

Referring to FIG. 19, the tether piece 300 and shield piece 310 are positioned overlying each other with their lengths extending parallel to each other. The shield piece 310 is folded along its length around the tether piece 300 to define overlapping top portions 312. The shield piece 310 thus wraps around the tether piece 300, thus sandwiching the tether piece between a bottom portion 314 and the overlapping top portions 312. Longitudinal stitching 320 extends through the overlapping top portions 312, the tether piece 300, and the bottom portion 314 to secure the shield piece 310 to the tether piece.

In the embodiment of FIG. 19, the stitching 320 comprises two parallel stitch lines (e.g., double needle lock stitching) that extend along the lengths of the tether piece 300 and shield piece 310. Those skilled in the art, however, will appreciate that the stitching 320 may comprise more or fewer stitch lines or may comprise stitching that is arranged in a non-linear pattern, such as a zig-zag pattern (not shown). Those skilled in the art will also appreciate that the stitching 320 could be replaced with alternative means for interconnecting the tether piece 300 and shield piece 310, such as ultrasonic welding, heat bonding, adhesives, or mechanical fasteners.

Once the shield piece 310 is stitched to the tether piece 300, the two are folded into the T-shaped configuration shown in FIG. 19 to define the attachment member 140b. The attachment member 140b includes a main portion 350 (the base of the T-shaped configuration) and a cross piece 360 (the cross portion of the T-shaped configuration). The cross piece 360 helps define the first portion 90b of the tether 12b. The main portion 350 helps define the second portion 92b of the tether 12b. As shown in FIG. 19, the main portion 350 and cross piece 360 each comprise two overlying layers of the shield piece 310 wrapped around the tether piece 300.

When the tether piece 300 and shield piece 310 folded to form the T-shaped attachment member 140b, the overlying layers defining the main portion 350 are interconnected via stitching 352 and the overlying layers defining the cross piece 360 are interconnected via stitching 362 (e.g., double needle lock stitching). As viewed from top to bottom in FIG. 19, the stitching 352 extends through the overlapping top portions 312 of the tether piece 310, through the tether piece 300, through overlying bottom portions 314 of the tether piece, again through the tether piece, and again through the top portions. The stitching 362 extends through the tether piece 300 and shield piece 310 in a similar fashion. The stitching 362 extends through the cross piece 360 at two different locations on the cross piece, on opposite sides of the main portion 350.

In the embodiment of FIG. 19, the stitching 352 comprises two parallel stitch lines that extend transverse (e.g., perpendicular) to the length of the tether piece 300 and shield piece 310 and to the stitching 320. At each location of the stitching 362, the stitching comprises two parallel stitch lines that extend transverse to the length of the tether piece 300 and shield piece 310 and to the stitching 320. Those skilled in the art, however, will appreciate that the stitching 352 and 362 may comprise more or fewer stitch lines or may comprise stitching that is arranged in a non-linear pattern, such as a zig-zag pattern (not shown). Those skilled in the art will also appreciate that the stitching 352 and 362 could be replaced with alternative means for interconnecting the tether piece 300 and shield piece 310, such as ultrasonic welding, heat bonding, adhesives, or mechanical fasteners.

Referring to FIG. 20, the vent member 14b may have a configuration that is similar or identical to that illustrated in either of the first or second embodiments. For example, in the third embodiment, the vent member 14b includes bend tabs 270b for helping to secure the attachment member 140b to the vent member. As shown in FIG. 20, the second portion 92b of the tether 12b, i.e., the main portion 350, of the attachment member 140b is positioned extending through an opening 272b of the vent member 14b. This may be done in a variety of manners. For example, the main portion 350 may be positioned extending through the opening 272b by first inserting the main portion 350 through the opening until the cross piece 360 moves into engagement with the vent member 14b.

Once the main portion 350 is positioned extending through the opening 272b, the first portion 90b of the tether 12b, i.e., the cross piece 360, is pulled tight against the vent member 14b and the bend tabs 270b are bent around the cross piece 360 to help further secure the cross piece, and thus the tether 12b, to the vent member 14b. The bend tabs 270b may exert a clamping force that helps secure the tether 12b to the vent member 14b.

When the tether 12b is tensioned, the crosspiece 360 is urged against the vent member 14b and transfers a force from the tether to the vent member for moving the vent member to the second condition. The present invention enables an accurate positioning of the attachment member 140b along the length of the tether 12b. As a result, the tethers 12b of the air bag module 10b may have a uniform length so that the vent members 14b are all moved to the second condition at the same position of the outer panel as it moves during inflation of the air bag (see FIGS. 1 and 2). Additionally, uniformity of the tether lengths is maintained in the manufacture of multiple air bag modules so that all of the air bag modules will have similar performances.

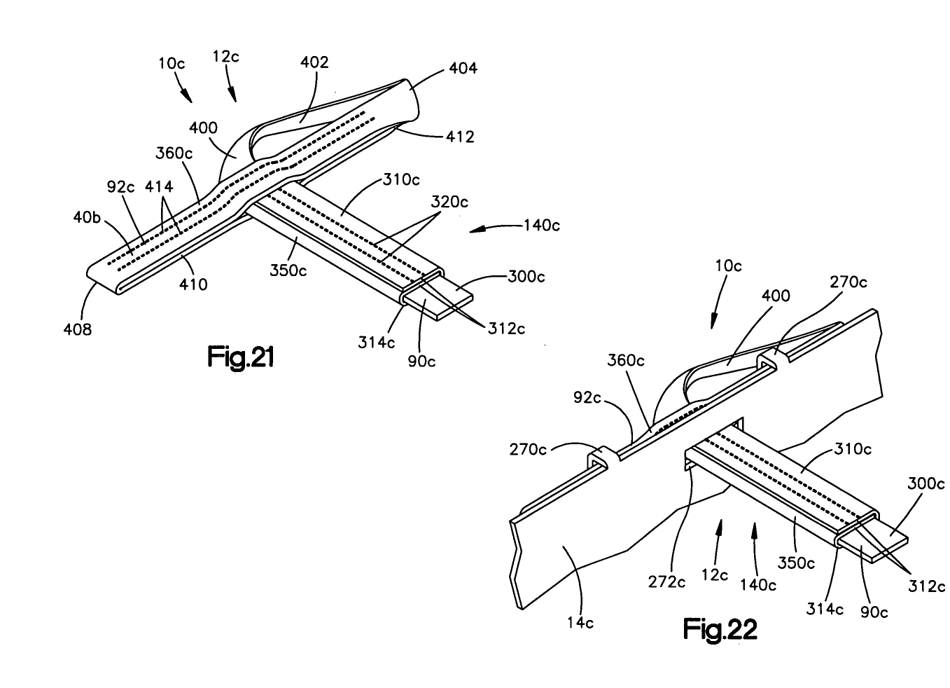

A fourth embodiment of the present invention is illustrated in FIGS. 21 and 22. The fourth embodiment of the present invention is similar to the second embodiment of the invention illustrated in FIGS. 19 and 20. Accordingly, reference numbers similar to those of FIGS. 19 and 20 will be utilized in FIGS. 21 and 22, the suffix letter “c” being associated with the reference numbers of FIGS. 21 and 22 to avoid confusion.

FIG. 21 illustrates a perspective view of one of the tethers 12c of the vehicle occupant protection apparatus 10c. The tether 12c includes a first portion 90c and a second portion 92c. According to the fourth embodiment, the tether 12c comprises a length of tether material that defines a tether piece 300c and a shield piece 310c that are secured to each other and folded to form an attachment member 140c as described below.

The tether piece 300c and shield piece 310c may have a material construction similar or identical to those described above in regard to the tether of the third embodiment. For example, the tether piece 300c may be a narrow elongated strip of fabric material (e.g., braided nylon or polyester) having widths of approximately three-eights of an inch. The shield piece 310c may comprise a widened strip constructed of a material that is the same as or different from that used to construct the tether piece 300c.

Referring to FIG. 21, the tether piece 300c and shield piece 310c are positioned overlying each other with their lengths extending parallel. The shield piece 310c is folded along its length around the tether piece 300c to define overlapping top portions 312c. The shield piece 310c wraps around the tether piece 300c and sandwiches the tether piece between a bottom portion 314c and the overlapping top portions 312c. Longitudinal stitching 320c extends through the overlapping top portions 312c, the tether piece 300c, and the bottom portion 314c to secure the shield piece 310c to the tether piece.

In the embodiment of FIG. 21, the stitching 320c comprises two parallel stitch lines (e.g., double needle lock stitching) that extend along the lengths of the tether piece 300c and shield piece 310c. Those skilled in the art, however, will appreciate that the stitching 320c may comprise more or fewer stitch lines or may comprise stitching that is arranged in a non-linear pattern, such as a zig-zag pattern (not shown). Those skilled in the art will also appreciate that the stitching 320c could be replaced with alternative means for interconnecting the tether piece 300c and shield piece 310c, such as ultrasonic welding, heat bonding, adhesives, or mechanical fasteners.

Once the shield piece 310c is stitched to the tether piece 300c, the tether piece is folded to form the generally T-shaped configuration of the attachment member 140c. In this configuration, the attachment member 140c includes a main portion 350c (the base of the T-shaped configuration) and a cross piece 360c (the cross portion of the T-shaped configuration). The cross piece 360c helps define the first portion 90c of the tether 12c. The main portion 350c helps define the second portion 92c of the tether 12c. As shown in FIG. 21, the main portion 350c comprises two overlying layers of the shield piece 310c wrapped around the tether piece 300c and the cross piece 360c comprises overlying portions of the tether piece 300c folded to overlie each other.

To form the generally T-shaped configuration of the attachment member 140c, the tether piece 300c is initially bent or folded along a first fold 400 to define a first segment 402 of the cross piece 360c. The first segment 402 extends along about one half of the length of the cross piece 360c.

The tether piece 300c is then folded back along a second fold 404 to define a second segment 406 of the cross piece 360c that intersects and extends across the main portion 350c. The second segment 406 extends along the entire length of the cross piece 360c and is oriented generally perpendicularly to the main portion 350c.

The tether piece 300c is then folded back along a third fold line 408 to define a third segment 410 of the cross piece 360c that overlies the second segment 406. The third segment 410 intersects and extends across the main portion 350c and may extend along the entire length of the cross piece 360c. The third segment 410 is oriented generally perpendicularly to the main portion 350c. The third segment 410 has a terminal end 412 that is positioned adjacent or near the second fold 404.

When the tether piece 300c is folded as described above to form the T-shaped attachment member 140c, the overlying layers defining the cross piece 360c are interconnected via stitching 414 (e.g., double needle lock stitching). As viewed from top to bottom in FIG. 21, the stitching 414 extends through the overlapping second segment 406 of the cross piece 360c, through the main portion 350c of the attachment member 140c, and through the third segment 410 of the cross piece. As shown in FIG. 21, the stitching 414 may extend through the shield piece 310c and tether piece 300c of the main portion 350c. Alternatively, the attachment member 140c could be configured such that the stitching 414 extends through the tether piece 300c only.

In the embodiment of FIG. 21, the stitching 414 comprises two parallel stitch lines that extend in a linear pattern generally parallel to the length of the cross piece 360c. Those skilled in the art, however, will appreciate that the stitching 414 may comprise more or fewer stitch lines or may comprise stitching that is arranged in a non-linear pattern, such as a zig-zag pattern (not shown). Those skilled in the art will also appreciate that the stitching 414 could be replaced with alternative means for interconnecting the overlying portions of the tether piece 300c and shield piece 310c, such as ultrasonic welding, heat bonding, adhesives, or mechanical fasteners.

Referring to FIG. 22, the vent member 14c may have a configuration that is similar or identical to that illustrated in any of the previous embodiments. For example, in the fourth embodiment, the vent member 14c includes bend tabs 270c for helping to secure the attachment member 140c to the vent member. As shown in FIG. 22, the second portion 92c of the tether 12c, i.e., the main portion 350c, of the attachment member 140c is positioned extending through an opening 272c of the vent member 14c. This may be done in a variety of manners. For example, the main portion 350c may be positioned extending through the opening 272c by first inserting the main portion 350c through the opening until the cross piece 360c moves into engagement with the vent member 14c.

Once the main portion 350c is positioned extending through the opening 272c, the first portion 90c of the tether 12c, i.e., the cross piece 360c, is pulled tight against the vent member 14c and the bend tabs 270c are bent around the cross piece 360c to help further secure the cross piece, and thus the tether 12c, to the vent member 14c. The bend tabs 270c may exert a clamping force that helps secure the tether 12c to the vent member 14c.

When the tether 12c is tensioned, the crosspiece 360c is urged against the vent member 14c and transfers a force from the tether to the vent member for moving the vent member to the second condition. The present invention enables an accurate positioning of the attachment member 140c along the length of the tether 12c. As a result, the tethers 12c of the air bag module 10c may have a uniform length so that the vent members 14c are all moved to the second condition at the same position of the outer panel as it moves during inflation of the air bag (see FIGS. 1 and 2). Additionally, uniformity of the tether lengths is maintained in the manufacture of multiple air bag modules so that all of the air bag modules will have similar performances.

From the above description of the invention, those skilled in the art will perceive improvements, changes and modifications. Such improvements, changes and modifications within the skill of the art are intended to be covered by the appended claims.

Having described the invention, we claim the following:

1. An apparatus for controlling flow of inflation fluid through a vent opening in an air bag module, the apparatus comprising:
a vent member movable to control flow of the inflation fluid through the vent opening, the vent member comprising a vent member opening extending through the vent member; and
a tether for controlling movement of the vent member, the tether comprising first and second portions, the second portion being folded to form multiple layers;
the tether being positioned relative to the vent member so that the multiple layers of the second portion engage a first side of the vent member, the first portion of the tether extending through the vent member opening and away from an opposite second side of the vent member, the engagement of the second portion with the vent member causing the vent member to move in response to movement of the tether.

2. The apparatus recited in claim 1, wherein the first and second portions of the tether comprise portions of a single length of tether material.

3. The apparatus recited in claim 1, wherein the first and second portions of the tether comprise separate lengths of tether material secured to each other.

4. The apparatus recited in claim 1, wherein the second portion of the tether is configured to extend generally perpendicular to the first portion of the tether.

5. The apparatus recited in claim 1, wherein the tether is positioned relative to the vent member by pulling the multiple layers of the second portion through the vent member opening from the second side of the vent member to the first side of the vent member.

6. The apparatus recited in claim 1, wherein the multiple layers of the second portion of the tether comprise a portion having a first number of layers and an adjacent portion having a second number of layers, the second number of layers being less than the first number of layers.

7. The apparatus recited in claim 6, wherein the portion having a second number of layers is initially passed through the vent member opening from the second side of the vent member and the portion having the first number of layers is subsequently passed through the vent member opening from the second side of the vent member to position the second portion of the tether adjacent the first side of the vent member.

8. The apparatus recited in claim 6, wherein the portion having a second number of layers is initially passed through the vent member opening from the second side of the vent member until the portion having the first number of layers abuts the vent member, the portion having the second number of layers subsequently being pulled from the first side of the vent member to move the portion having the second number of layers and the portion having the first number of layers through the vent member opening to position the first portion of the tether adjacent the first side of the vent member.

9. The apparatus recited in claim 6, wherein the first number of layers is at least three and the second number of layers is one less than the first number of layers.

10. The apparatus recited in claim 1, wherein the first portion of the tether is pulled away from the vent member to bring the first portion of the tether into abutting engagement with the first side of the vent member.

11. The apparatus recited in claim 1, wherein the multiple layers of the second portion of the tether are secured together.

12. The apparatus recited in claim 1, wherein the multiple layers of the second portion of the tether are stitched together.

13. The apparatus recited in claim 10, wherein the stitching extends along a length of the tether.

14. The apparatus recited in claim 3, wherein the first portion of the tether is wrapped perpendicularly around the second portion of the tether and connected to the second portion of the tether.

15. The apparatus recited in claim 1, further comprising a shield piece that covers at least a portion of the tether.

16. The apparatus recited in claim 1, wherein the vent member comprises bend tabs configured to clamp onto the second portion of the tether to help secure the tether to the vent member.

17. The apparatus recited in claim 1, wherein the first and second portions of the tether comprise portions of a single length of tether material, the second portion comprising an end portion of the tether that is folded to orient the second portion perpendicular to the first portion, the folded second portion having overlying portions interconnected to maintain the perpendicular orientation.

18. The apparatus recited in claim 17, wherein the second portion of the tether lies flat against the first side of the vent member.

19. The apparatus recited in claim 17, wherein the folded second portion of the tether comprises:
a first segment folded to extend transverse to the first portion of the tether;
a second segment folded to extend opposite the first segment across the first portion of the tether and intersecting the first portion of the tether; and
a third segment folded to extend parallel to the second segment across the first portion of the tether and intersecting the first portion of the tether, the third segment overlying the second segment.

20. The apparatus recited in claim 19, wherein the second and third segments extend perpendicular to the first portion of the tether.

21. The apparatus recited in claim 19, wherein the second and third segments are interconnected.

22. The apparatus recited in claim 19, wherein the second and third segments are interconnected with each other and with the first portion of the tether.

23. The apparatus recited in claim 19, wherein the second and third segments extend on opposite sides of the first portion of the tether.

24. The apparatus recited in claim 1, wherein the vent member is movable in response to tension applied to the first portion of the tether.

25. The apparatus recited in claim 24, wherein the first portion of the tether is connectable with a panel of an inflatable vehicle occupant protection device such that the first portion of the tether is tensioned during deployment of the protection device.

26. An apparatus for controlling flow of inflation fluid through a vent opening in an air bag module, the apparatus comprising:
a vent member movable to control flow of the inflation fluid through the vent opening; and
a tether for controlling movement of the vent member, the tether comprising first and second portions, the second portion being folded to form multiple layers and the first portion extending from the multiple layers;
the tether being positioned relative to the vent member so that the multiple layers of the second portion are maintained in engagement with a surface of the vent member, the engagement of the folded second portion with the surface of the vent member causing the vent member to move in response to tension on the first portion of the tether.

27. The apparatus recited in claim 26, wherein the first portion of the tether is connectable with a panel of an inflatable vehicle occupant protection device such that the first portion of the tether is tensioned during deployment of the protection device.

28. An apparatus for controlling flow of inflation fluid through a vent opening in an air bag module, the apparatus comprising:
a vent member movable to control flow of the inflation fluid through the vent opening; and
a tether for controlling movement of the vent member, the tether comprising first and second portions, the second portion comprising portions of the tether folded into multiple layers and secured to help maintain the folded multiple layer configuration of the second portion,
the first portion extending through an opening in the vent member, the second portion being sized to form an interference with the vent member so that movement of the tether effects movement of the vent member.

29. An apparatus for helping to protect an occupant of a vehicle, the apparatus comprising:
an inflatable vehicle occupant protection device inflatable between structure of the vehicle and a vehicle occupant;
an inflation fluid source for providing inflation fluid for inflating the protection device;
structure defining a housing for supporting the protection device and inflation fluid source, the housing comprising a vent opening;
a vent member movable to control inflation fluid flow through the vent opening, the vent member comprising a vent member opening extending through the vent member; and
a tether for controlling movement of the vent member, the tether comprising first and second portions, the second portion being folded to form multiple layers that engage a first side of the vent member, the first portion of the tether extending through the vent member opening and away from an opposite second side of the vent member, the first portion of the tether being configured for movement in response to deployment of the protection device, the engagement of the second portion with the vent member causing the vent member to move in response to movement of the first portion of the tether.
